(19) United States
(12) Patent Application Publication
(10) Pub. No.: US 2014/0279289 A1
(43) Pub. Date: Sep. 18, 2014

(54) Mobile Application and Method for Virtual Dressing Room Visualization

(71) Applicant: Mary C. Steermann, Barrington Hills, IL (US)

(72) Inventor: Mary C. Steermann, Barrington Hills, IL (US)

(21) Appl. No.: 14/215,649

(22) Filed: Mar. 17, 2014

Related U.S. Application Data
(60) Provisional application No. 61/787,533, filed on Mar. 15, 2013.

(51) Int. Cl. G06Q 30/06; G06T 11/60

(52) U.S. Cl. CPC G06Q 30/0643; G06T 11/60
USPC 705/27.2

(57) ABSTRACT

A mobile application enables an online shopper to see how an item of clothing will look on them—simulating an actual trying-it-on-session in the dressing room—before purchasing it. The online shopper downloads the TRY IT ON—ONLINE™ mobile application to his or her mobile communications device. Once the shopper has downloaded the mobile application to his or her mobile communications device, a series of prompts ask the shopper for information about their size, body shape, and skin tone. Once the screens are populated with this information, the mobile application guides the shopper through their online shopping excursion, and, like a personal shopper, helps them select an article of clothing that will fit and flatter their body shape. Before purchasing the item, the shopper can try it on virtually just as if they were in a dressing room at the store.

### PRIOR HISTORY

This non-provisional patent application claims the benefit of U.S. Provisional Patent Application No. 61/787,533 filed in the United States Patent and Trademark Office on 15 Mar. 2013.

### BACKGROUND OF THE INVENTION

1. Field of the Invention

The present invention relates generally to certain apparatus and methods for purchasing items of clothing. More particularly, the present invention relates to a mobile application for a mobile communication device, such as a mobile telephone, wireless enabled personal digital assistant (mobile communication device), or the like, which allows a user to quickly view the items of clothing as being worn by the user or another person.

2. Brief Description of the Prior Art

Online Retailers spend millions of dollars each year processing returns from customers who selected the wrong size, a style that does not flatter their figure, or a color that does not complement their skin tone. Shoppers have a difficult time visualizing how an article of clothing will look on them without trying it on. The shopper purchases the item of clothing anyway, but then is disappointed when they try it on at home and find that the size they ordered does not fit and then they have to return it.

Clothing sizes varying from one manufacturer to the next—the traditional size 10 may be a size 8 in a Designer brand—but when a shopper is in the store, they can try on the size 10 and the size 8 to see which one fits better. Since the online shopper cannot try the clothes on before purchasing them, they tend to order their traditional size, and figure they can return it if it does not fit. Some shoppers may order two different sizes, but then they are still returning one, but what if they do not like the color or the style is not flattering to their figure? Then both items go back, the shopper has wasted her time shopping and the online retailer is stuck with the cost of processing returned merchandise.

The solution to both of these problems is the Try it on—Online™ mobile application according to the present invention. The Try it on—Online mobile application according to the present invention helps the shopper to select a size that fits; a style that flatters their figure; and a color that compliments their skin tone. For the online retailer, it will drastically reduce merchandise returns, saving online retailers millions of dollars each year, and increase their customer base.

Certain prior art generally related to this type of invention are briefly described hereinafter. U.S. Pat. No. 4,486,774 ('774 patent), which issued to Maloomian, discloses a System and Method for Composite Display. The '774 patent describes an apparatus that allows a prospective consumer of articles of clothing to try on one or more articles of clothing without actually putting the articles of clothing on his or her person. This is accomplished by means of an electronically produced full figure image which is composed of the consumer's head and a model's body, the model's body attired in articles of clothing to be presented. The composite image is viewed by the consumer on a television screen and this gives the effect of the consumer being attired in the articles of clothing presented.

U.S. Pat. No. 5,680,528 ('528 patent), which issued to Korszun, discloses a Digital Dressing Room. The '528 patent describes a system of software programs and a database of digital images, including garment images and a basic model body image, which allows a client to select and “try on”—individually or by mixing and matching—the different garment images of the database. The system renders an image of the client's body in the garments, with the client's specific curves, bulges and height which reflect the client's body measurements. Broadly, the system comprises two parts, namely, a pre-process and an online process.

The preprocess prepares the images for inclusion in the database and addresses the following issues: photographing and digitizing the images, deriving stencils of the images, correcting image mis-alignments, centering the basic model body, detaching the arms/sleeves of the images, classifying garments, and others. The online process, which employs image processing techniques including geometric transformations (such as digital warping), translations, rotations, edge detection, and others, takes as user inputs the client's measurements—bust, waist, hips, and height, for example—and the selected garments.

It then layers the garment(s), thus creating an ensemble, transforms the basic model body to reflect the client's height, translates the ensemble unto the body reflecting the client's height, analyzes the amount of garment ease in the ensemble, reshapes the torso of the clad body to show the client's girths, calculates the trigonometric functions used to re-attach untransformed arms/sleeves, and then attaches arms/sleeves unto the reshaped torso. The result is a rendering of a clothing ensemble as it would drape a body with the client's measurements.

U.S. Pat. No. 6,546,309 ('309 patent), which issued to Gazzulo, describes a Virtual Fitting Room. The '309 patent describes a method for enabling a customer to virtually try on a selected garment is disclosed. First, a mathematical model of the customer's body and a garment model for the selected garment are retrieved. The garment model includes a plurality of fit factors. Next, a size of the garment that will best fit the customer is determined by comparing the fit factors of the garment model to the mathematical model of the customer's body. Finally, a fit analysis data of the selected garment in the determined size on the customer is determined for each of the fit factors by comparing each of the fit factors of the determined size garment to the mathematical model of the customer's body.

U.S. Pat. No. 6,661,433, ('433 patent), which issued to Lee, describes a Portable Wardrobe Previewing Device. The '433 patent describes a wardrobe previewing system that allows a person to preview how clothing items will look on her without having to put on the clothing items. The wardrobe previewing system includes a portable device, clothing tags for identifying clothing items, and a means for storing clothing item images. The portable device further includes a scanner capable of reading the clothing tags, a display, and application software for enabling the portable device to display a preview of clothing items on the person.

In addition, an image of the person is stored in the memory of the portable device. The person scans the clothing tag of a potential clothing item with the scanner, and retrieves a clothing item image corresponding to the scanned clothing item. The application software overlays the retrieved clothing item image onto the image of the person stored in the memory of the portable device to produce a composite image. The application software then displays the composite image on the display of the portable device to give the person a preview of how the clothing item will look on her.

U.S. Pat. No. 5,163,008 ('007 patent), which issued to Silaty, discloses a System for Measuring Garments. The '007 patent describes method for generating custom clothing dimensions. Data is entered into a computer processor. The data represents a set of measurements defining a subject's body size and shape, the subject's clothing style and preference, and the subject's physical characteristics. The subject's physical characteristics may be interpreted from a photograph of the subject. Final dimensions of the clothing are generated as a function of the entered data. The final dimensions are then displayed. Finally, an evaluation of the final measurements and dimensions can be made, based on the subject's history.

U.S. Pat. No. 6,968,075 ('075 patent), which issued to Chang, discloses a System and Method for Three-Dimensional Shape, and Size Measurement. The '075 patent describes a method for three-dimensional shape and size measurement of a three-dimensional body surface comprising providing a three-dimensional scanner, providing a processor, providing a three-dimensional Computer Aided Design system, scanning in three dimensions with the three-dimensional scanner at least a portion of the three-dimensional body surface, creating a data file representative of the three-dimensional body surface, processing the data file with the processor, importing the data file into the three-dimensional Computer Aided Design System, employing the three-dimensional Computer Aided Design System relative to the data file to define and record three-dimensional measuring data relative to at least a portion of the three-dimensional body surface, and employing the three-dimensional Computer Aided Design System to exploit the three-dimensional measuring data.

U.S. Pat. No. 7,194,327 ('327 patent), which issued to Lam, discloses a Body Profile Coding Method and Apparatus Useful for Assisting Users to Select Wearing Apparel. The '327 patent describes a computer supported system especially configured for users to easily coordinate or harmonize apparel before making a purchasing decision. The embodiments include a body profile generating, encoding and decoding system. The system defines a display region configured for displaying the personalized real human facial image of a user combining the visual image of a selected garment. The shape and size of the garment is faithfully adjusted in accordance to the body profile coding parameters of the garment. The database representing the facial images of users is shared by different stores.

U.S. Pat. No. 7,548,794 ('794 patent), which issued to Vandergriff et al., discloses a Virtual Sizing System and Method. The '794 patent describes a systems and methods for selecting, ordering, or furnishing apparel for individual members of a group such that the group members dressed to project a commonly-governed image. One or more image criteria are established that associate a set of apparel specifications with corresponding body properties according to the commonly-governed image to be maintained for the group.

Virtual sizing sessions are conducted with participating members of the group via an interactive virtual sizing application interfaced with a computer network. User-specific information from a set of users (e.g., group members) is automatically gathered over the computer network, and a set of virtual sizing results is generated by at least processing user-specific information gathered from the set of users. The processing is based on the image criteria.

U.S. Pat. No. 7,711,600 ('600 patent), which issued to Curran et al., discloses an In-Store Self-Service Ordering Guide System and Method. The '600 patent describes self-service shopper ordering guide system and method for use by retailers to customize product ordering promotions. An ordering guide database is synchronized with the retailer's product and inventory databases so that current product data is available to the system. The self-service ordering guide system comprises tools for developing and deploying screens to self-service terminals located throughout a store.

A screen flow editor prompts a user to define screens for an order flow and to specify products from the ordering guide database to include on screens. The user's selections populate screen templates that comprise an order flow. Photographs and files for use in the screens and sub-screens allow a retailer to create a customized look. A shopper using an in-store terminal is prompted to make selections from the screens to create an in-store order. The ordering guide system is further integrated with the retailer's fulfillment system for processing online orders.

United States Patent Application No. 2001/0026272, which was authored by Feld et al, describes a system and method for designing a wear article for an object comprises providing a virtual three-dimensional model of the object, including first data representing three dimensions of the object. Virtual two-dimensional patterns representing different portions of the wear article are assembled into a virtual three-dimensional wear article. The virtual three-dimensional wear article includes second data representing three dimensions of the wear article. A material type is associated with one or more of the virtual patterns and the virtual three-dimensional wear article.

The material type has third data representing at least one physical property of the material type. In order to display the virtual three-dimensional wear article on the virtual three-dimensional model, the first and second data are compared to determine the non-intersection of the virtual three-dimensional wear article with the virtual three-dimensional object. The virtual three-dimensional wear article is then conformed to the virtual three-dimensional model within constraints imposed by the third data. With this arrangement, the system and method enables the virtual wear article to stretch, flex, sag, etc., on the virtual model to better approximate the real-life fit and look of the wear article on an object during design of the wear article.

United States Patent Application No. 2002/0004763, which was authored by Lam, describes a computer supported system especially configured for users to easily coordinate or harmonize apparel before making a purchasing decision. The embodiments include a body profile generating, encoding and decoding system. The system provides the conversion of a body profile code to fit with a particular garment size defined by a garment size chart. The enhanced body profile coding and decoding system also provide flexibility and room for future expansion and applications.

United States Patent Application No. 2002/0188372, authored by Lane et al., describes a method for indicating a fitting condition of a garment on a virtual model of a person. One or more fitting points and corresponding measurements of the garment relevant for examining the fitting condition of the garment on the virtual model are identified first. One or more fitting preferences for the garment are also indicated. Poor fit locations on the virtual model are then highlighted after examining the person's fitting preferences against the measurements of the fitting points. The person can use the virtual model for examining whether the garment fits well in order to make a purchase decision in an interactive remote shopping session.

United States Patent Application Nol. 2003/0011590 which was authored by Kung et al., describes a method which includes the steps of: a) importing three-dimensional digital data representative of at least one portion of the body (C) of a working virtual mannequin, b) generating three-dimensional digital data representative of a virtual structure (O) including a series of lines disposed each in one of a plurality of transverse and longitudinal section planes of said body, said lines being at each point spaced by a particular distance from the surface of said working virtual mannequin body (C), c) selectively generating and displaying from said digital data at least one image of at least one area of the elements comprising said virtual structure (O) and said portion of said working virtual mannequin body (C), d) selectively modifying at various points (T) of said virtual structure (O) said distance between said lines and said surface to generate a personalized virtual structure representative of said garment, and e) modifying said image as a function of said modifications made to said virtual structure (O).

United States Patent Application Publication No. 2004/0080530, authored by Lee, describes a wardrobe previewing system that allows a user to preview how clothing items will look when worn without having to put on the clothing items. The wardrobe previewing system includes a mobile communication device, clothing tags for identifying clothing items, and a means for storing clothing item images. The mobile communication device further includes a camera capable of capturing an image of the clothing tags, a display, and application software for enabling the mobile communication device to display a preview of clothing items on the user. The application software overlays the retrieved clothing item image onto the image of the user or, alternatively, a second person, stored in the memory of the mobile communication device to produce a composite image. The application software then displays the composite image on the display of the mobile communication device to give the user a preview of how the clothing item will look when worn.

United States Patent Application Nol. 2007/0005174, authored by Thomas, describes a method, system and/or computer program product for virtual apparel fitting may include transmitting an identification code for an article of apparel to a virtual apparel fitting system. The method, system and/or computer program product may also include transmitting one of a 3-D body model, a 3-D body model identifier or a set of body measurements to the virtual apparel fitting system. The method, system and/or computer program product may further include presenting a virtual representation of the article of apparel applied to one of the 3-D body model, another 3-D body model corresponding to the 3-D body model identifier, or a further 3-D body model generable from the set of body measurements, wherein the virtual representation of the article of apparel applied to one of the 3-D body models is presentable in response to receiving the virtual representation from the virtual apparel fitting system.

It will be seen from a review of the foregoing in particular, and the field of mobile applications in general that the prior art perceives a need for a mobile application system and method for enabling an online shopper to see how an item of clothing will look on them—simulating an actual trying-it-on-session in the dressing room—before purchasing it according to the specifications attendant to the present invention.

The online shopper downloads the TRY IT ON—ONLINE™ mobile application to his or her mobile communications device. Once the shopper has downloaded the mobile application to his or her mobile communications device, a series of prompts ask the shopper for information about their size, body shape, and skin tone. Once the screens are populated with this information, the mobile application guides the shopper through their online shopping excursion, and, like a personal shopper, helps them select an article of clothing that will fit and flatter their body shape. Before purchasing the item, the shopper can try it on virtually just as if they were in a dressing room at the store as summarized in more detail hereinafter.

### SUMMARY OF THE INVENTION

The present invention essentially provides a mobile application, i.e. the TRY IT ON—ONLINE™ mobile application, is an application that enables the online shopper to hold a personal shopper in the shopper's hand. The mobile application according to the present invention takes the guesswork out of selecting the appropriate size and style of clothing for the online shopper. One of the unique features of the TRY IT ON—ONLINE™ mobile application is that it allows the online shopper to see how an item of clothing will look on them—simulating an actual trying-it-on-session in the dressing room-before purchasing it. The online shopper downloads the TRY IT ON—ONLINE™ mobile application to his or her mobile communications device, which mobile application is tailored to men, women, and children with appropriate size charts developed for each group.

Once the shopper has downloaded the mobile application to their mobile communications device, a series of prompts ask the shopper for information about their size, body shape, and skin tone. Once the screens are populated with this information, the mobile application guides the shopper through their online shopping excursion, and, like a personal shopper, helps them select an article of clothing that will fit and flatter their body shape. Before purchasing the item, the shopper can try it on virtually just as if they were in a dressing room at the store.

The best way to try on clothing items online and ensure a good fit before making a purchase is to download the TRY IT ON—ONLINE™ mobile application. There are size charts on the websites that are accessible to the shopper, but most shoppers are in a hurry when they are shopping and do not take the time to look at those charts. Besides, few people know their body measurements and they end up ordering clothes based on the size they always wear. Clothing sizes—4, 6, 8, 10, 12, and 14 vary from one manufacturer to the next. A size 12 from Donna Karan and a size 12 from Armani will have different body proportions in the bust, waist, and hips. The shopper really needs to try on the clothing before purchasing it to ensure an accurate fit.

The TRY IT ON—ONLINE™ mobile application according to the present invention has benefits for all who use the application. The application helps the shopper find the perfect look and fit for their body type when shopping for clothes online and the online retailer will save millions of dollars each year processing returned merchandise. The shopper could use this at any online clothing retailer, they would be able to email pictures of themselves to friends and family, or upload their picture to Facebook to get opinions from their Facebook community.

The retailer's website would allow them to track the shoppers purchasing habits—clothing style, brand, sizes and colors—and when new merchandise becomes available, the retailer could alert the shopper to new clothing items that would be of interest to them. The shopper would be able to reserve their own “virtual dressing room” on the retailer's website where the retailer could place items for shopper for to try on at their leisure. This software will help the retailer to increase their customer base and reduce costly merchandise returns.

### BRIEF DESCRIPTION OF THE DRAWINGS

Other features and objects of my invention will become more evident from a consideration of the following brief descriptions of illustrations of the subject invention:

FIG. 1 is a graphical depiction of a compilation of a number of body types, including from left to right, triangle, inverted triangle, rectangle, hourglass, diamond, and round body types.

FIG. 2 is a graphical depiction of a compilation of a number of skin colors and skin tones.

FIG. 3 is a generic graphical depiction of a photographic image, including an image of a person having a facial feature, a body feature, facial ornamentation against a photographic backdrop.

FIG. 4 is a generic graphical depiction of a modified facial feature as manipulated or modified from the photographic image otherwise shown in FIG. 3.

FIG. 5 is a graphical depiction of a generic retailer website showing a photographic image of a modeled article of clothing.

FIG. 6 is a generic graphical depiction of the photographic image otherwise shown in FIG. 5.

FIG. 7 a graphical depiction of a manipulated or modified clothing image taken from FIG. 6 juxtaposed in inferior adjacency to a manipulated or modified facial image from FIG. 4.

FIG. 8 a graphical depiction of the manipulated clothing image and manipulated or modified facial image from FIG. 7 displayed upon a visual display of mobile communications device.

FIG. 9 is a generic body size chart showing a variety of body size characteristics including clothing size, bust, natural waist, lower waist, and hip size attributes for variously sized persons.

FIG. 10 is a graphical depiction of a plurality of manipulated or modified clothing images juxtaposed in inferior adjacency to the manipulated or modified facial image for presenting a side-by-side comparison of the virtually donned articles of clothing.

FIG. 11 is a diagrammatic flow chart type depiction of various features of the mobile application according to the present invention.

FIG. 12 is a diagrammatic flow chart type depiction of the backend of the mobile application according to the present invention.

FIG. 13 is a graphical depiction of a map displayed upon a visual display of mobile communications device showing pinpointed retail outlets having clothing that matches the user's body shape and size data.

### DETAILED DESCRIPTION OF THE PREFERRED EMBODIMENT AND METHODOLOGY

Referring now to the drawings with more specificity, the present invention essentially provides mobile application software downloadable to a user's mobile communications device as generically depicted at 10 in FIG. 8 for further implementation as elected by the user. The user first downloads the mobile application software to his or her mobile communications device 10 from an application distribution platforms, such as from the APPLE iTunes application store, to their mobile communications device as exemplified by an iPhone smartphone or iPad tablet computer or similar other mobile communications device 10.

The mobile communications device 10 is essentially a mobile computer and thus comprises certain software implementation means, and in this case, necessarily certain data output means as preferably exemplified by a visual display screen as at 11. The mobile application software comprises certain means for prompting the user to enter information about the user into the mobile software application for further processing by the software. For example, the mobile application may initially prompt the shopper to enter information about their figure, as perhaps best embraced by body measurements, body shape, and skin tone.

This information is resident on the mobile application and is able to interact with an online retailer's website (a generic screenshot of which is generally depicted at 12 in FIG. 5) provided the online store's website is running a website based version of the TRY IT ON—ONLINE™ software. Assuming the online shopping site 12 is running the software, a specialized TRY IT ON—ONLINE brand logo as at 73 is displayed on the store's home page. This logo 73 is a signal to the online shopper that the online retailer is ready to let the shopper try on various clothing offerings online via their website.

The Retailer Website Software—

TRY IT ON—ONLINE™ Mobile application software 70 according to the present invention allows the retailer access to the shopper's input information as exemplified by bodily measurements, body shape, and skin tone. If the shopper has selected and tried on one dress at the retailer's website, and was dissatisfied with it, or it was not the right fit, the TRY IT ON—ONLINE™ software will prompt the shopper with a query asking the shopper if the shopper wishes to search that store's website to search for other options. If the shopper responds, “YES,” the TRY IT ON—ONLINE™ software will automatically search the site using the information entered by the user into the mobile application software as exemplified by bodily measurements, etc.

Although the online shopper has the option of searching the website again via the mobile application software, the online shopper may choose to navigate away from the particular website if dissatisfied with the final selection. Online shopping websites, as exemplified by Bloomingdale's, Macy's, and Nordstrom's, naturally do not want the online shopper to leave their respective websites and look elsewhere. A user's presence at a given retailer website is an opportunity for the online retailer to build a relationship with the online shopper, collect information about that online shopper, and market new merchandise to the online shopper.

One of the many benefits to the retailer is that the TRY IT ON—ONLINE software allows the retailer to create a virtual dressing room where a personal shopper (either actual or virtual) can continually place or queue items for the next time the customer visits the website. The retailer can routinely send emails to the shopper letting them know that their dressing room has items for them to try on. The online retailer can also recommend accessories to complement the clothing, as exemplified by purses, shoes, jewelry, and scarves.

The Shopper's Information—

As prefaced above, in order for the mobile application software to properly work, the online shopper is required needs to enter information about the online shopper into the mobile application software for further processing. The information that is required by the mobile application software may preferably include brand preference(s), body shape, body size, and photographic imagery of themselves.

For full functionality of the mobile application's features, it is recommended that the online shopper fill in all the requested information, although mobile application software contemplates alternative methodology for enabling the online shopper to opt out of providing certain information. For example, if the online shopper simply wants to have fun with the mobile application according to the present invention, the online shopper can select their body shape and upload a photograph to see how they would look in a new style or color.

The Online Shopper's Size Information:

The first screen requests information about the shopper's size, including the following information: BUST SIZE, CUP SIZE, NATURAL WAIST, LOW WAIST, HIPS, HEIGHT, WEIGHT, INSEAM, and SKIRT LENGTH. Before the online shopper enters their size information, as exemplified by the foregoing attributes, the online shopper has an opportunity or is invited to watch a “how-to” video implemented by the mobile application software that demonstrates to the online shopper how to properly take their measurements. The online shopper may be provided with strong encouragement to watch the video and follow the instructions for measuring so that their measurements are accurate. If the online shopper so chooses, they can skip this aspect of the mobile application.

The Online Shopper's Shape Information:

A further prompt queries the online shopper to select a body shape from the six basic body shapes 13 generally depicted in FIG. 1, namely, triangle as at 14; inverted triangle as at 15; rectangle as at 16; hourglass as at 17; diamond as at 18; and round as at 19. The online shopper chooses from among the body shapes 13 the body shape that most closely resembles the online shopper's body shape. The selection of a body shape provides the online shopper with a cursory fit based the online shopper's body shape and on the style of clothing that the shopper has selected.

The Online Shopper's Facial Information:

In order for the online shopper to see her or himself in a select article of clothing, the online shopper is required to input or upload photographic imagery of her as generically depicted at 20 in FIG. 3 into the mobile application software. The mobile application software preferably comprises a built-in graphic tool that automatically crops out the background 21, (inclusive of the person's non-facial bodily features 23 and any unwanted ornamentation such as earrings 24), corrects color, and sharpens the facial features.

This built-in graphic tool further preferably functions to enable the online shopper to select the shopper's skin color and skin tone from a compilation of skin colors and skin tones as at 22 in FIG. 2 that most closely resembles their own. For example, the person depicted in the photograph 20 may in reality have a medium complexion. However, the complexion displayed in the photograph 20 may appear as having an alternative complexion given certain shortcomings with the photograph 20. If the online shopper has accurately selected her complexion as medium, the built-in graphic tool will automatically correct or adjust the skin color and the skin tone in the photograph 20 shopper to render a final complexion-correct headshot 25 for further use with the mobile application software.

Functionality:

The primary purpose of the mobile application according to the present invention is to help the shopper select an article of clothing that fits and looks good on them, but the shopper can also use the mobile application for entertainment purposes or just for fun. In other words, no clothing purchase is required. The interactivity of the mobile application allows the shopper to explore a variety of styles and colors that they might otherwise be intimidating for the shopper to try on in a brick and mortar store.

Accordingly, the mobile application according to the present invention allows the shopper to be adventurous, and do so in the privacy of their own space via the mobile communications device 10. Thus, the shopper can try on outfits at will, or explore new online clothing websites, and try on a variety of styles without any pressure to purchase anything.

If the shopper does not know his/her size, or does not have time to properly enter size information, they can merely select a body shape from among the body shapes 13, upload a photograph as at 20, and see how a given style of clothing will look. The mobile application according to the present invention further contemplates certain functionality that will enable the shopper to upload their virtual imagery to one or more social network website(s) as exemplified by FACEBOOK to solicit feedback from those linked to the shopper at the social networking site in an effort to see what their friends think about their selection/creation.

Since the shopper's information is resident on the mobile application, the shopper has complete control over it at all times. The shopper's information can be updated daily if the shopper so chooses. Further, the shopper decides whether they want to share their information with retailers. However, unless a select retailer is running the TRY IT ON—ONLINE™ software on their website, the shopper will not be able to share this information with the website.

How the Mobile Application Works:

The shopper may begin by shopping online for a dress to wear to a special occasion. The shopper may find a dress at Bloomingdale's online website and clicks on the picture for more information regarding a certain article of clothing. A screenshot or web page 12 for the particular item of clothing 27 then opens showing a graphic of the (modeled) item of clothing 26. In other words, the retailer webpage for that particular item of clothing 27 opens and further displays particulars about the article of clothing or dress, such as color, style, fabric, length, etc. in certain areas 28 of the screen in adjacency to the graphic 26.

The TRY IT ON—ONLINE™ mobile application preferably functions to remove the model's headshot or face as at 29; creates a .jpeg graphic or image 30 of the dress or article of clothing; downloads the .jpeg image or graphic 30 to the mobile communication device 10 and displays the .jpeg graphic or image 30 of the dress or article of clothing based on the information the shopper has entered, and inserts the final complexion-correct headshot 25 in FIG. 7.

The mobile application according to the present invention further utilizes the measurements from the shopper's mobile application data entry and compares those measurements to the size chart 31 on the shopping website 12. The mobile application selects a size from chart 33 based on the largest body measurement of the shopper, and the dress or article of clothing 27 displays showing the actual fit of the dress or article of clothing 27 on the shopper's body.

If the dress fits in the bust and hips, but is loose in the waist, a size warning displays on the area (as at 32) of the dress or article of clothing 27. The shopper may then decide to purchase the dress or article of clothing 27 and have it altered, or search for another dress or article of clothing that would be a better fit for her figure. The shopper can search that website again, or navigate to another website.

If the online store displays the TRY IT ON—ONLINE™ logo 73 on its website, they can assist the shopper with an expedited search on the site. In this case, the shopper can click the TRY IT ON—ONLINE™ logo 73 on the retailer's website and the software returns several dresses or articles of clothing in a variety of styles that will fit the shopper's measurements, and the shopper can then virtually don the varied alternative articles of clothing as at 34 and 35 for side-by-side, at-once comparison in a single view as generally depicted in FIG. 10.

Technical Specifications:

This is the basic concept for the TRY IT ON—ONLINE™ mobile application designed to help online shoppers visualize potential online clothing purchases in a personalized and fun manner using their mobile communications device 10. The mobile application according to the present invention thus serves as a purchasing portal, connecting the would-be shopper to online shopping destinations via Application Programming Interfacing (API), and affiliate program participation.

It is contemplated that this mobile application will be introduced to the market via the Apple iTunes Application or App Store. The mobile application according to the present invention preferably comprises three main components, namely, (1) the consumer mobile application software 70; (2) the mobile application backend 60 that (a) serves data to the mobile application software 70 and (b) connects the user to online shopping destinations; and (3) the transaction server that will process and send payments.

Referencing FIG. 11, the reader will there see a diagrammatic depiction of the consumer mobile application 70 according to the present invention with flowchart type descriptions. The mobile application 70 enables users to create a TRY IT ON—ONLINE™ account as at 46 with social networking sites such as Facebook, Twitter, and/or Pinterest, or via E-mail confirmation.

The concept of the mobile application is presented in an alluring manner to would-be users of the application. This alluring presentation will help support a guided setup process 51 that provides sufficient information about the users' favorite brands as at 47, body type as at 48, generalized sizes as at 49, and a set 50 of usable photographs 20 to be used in the personalization process. This information is further used to present the user with an initial set of results to demonstrate the capabilities of the mobile application.

Users are able to continually access their account information as at 40 and make changes to or edit previously input information such as photographs as at 41, body shape(s) as at 42, and body size(s) as at 43. The users are further able to add and remove brands as at 44, as well as invite more friends to utilize the mobile application as at 45.

Viral Distribution—

After initial setup, the user is prompted to invite (via social networking sites) connected social friends as at 45 to utilize the mobile application so that they may see their friend's results in their rack. This concept carries with it the goal of creating dialogue between users and adds cohesion to the mobile application for aiding its distribution.

The Rack—

The mobile application is presented as a single feed view with several supporting screens. This simple presentation will collect various sources of data powered by the users' input of brands, styles, sizes, social connection and local findings. Each listed item is able to be viewed in detail by the user and when possible creates a transaction as at 52.

Saved Attempts 53—

Users are able to save items on their rack for easier browsing and sharing. These saved items will be placed in a sub-view of the Rack for simple access.

Shopping Map 54—

To present the mobile application 70 as a local shopping assistant to users, the mobile application will take advantage of the unique capability of mobile communications devices to present users with a map 54 view of connected retail stores 55 that have inventory matching the users' input as generally depicted in FIG. 13.

Referencing FIG. 12, the reader will there see a diagrammatic flowchart type depiction of mobile application backend 60 according to the present invention. The application API on the backend server connects the mobile application 70 to the different components of the overall system. The backend 60 handles file and data storage; e-commerce transactions, and the image personalization process.

The main feature of the consumer experience is the ability to take a product image and produce a composite version that presents a version of that image as at 30 with the user's shape and the user's face as at 25. Although it is contemplated that the image personalization process could be implemented on the customer's mobile communications device 10, a device-based processing system is apt to create too many non-parallel redundancies across different devices 10. Accordingly, the imager personalization process is preferably implemented on the server side to standardize and streamline the process in the mobile application. To illustrate these processes, before the user is served a product in the mobile application, the server would create the personalized image and then serve the item to the user upon completion.

The ideal scenario for retail partner integration is to connect to retailer product and transaction API's. This process requires identification of required data from retail partners, and feeds for that data into system data and file stores according to the present invention. When possible, the API also provides connection into any e-commerce or affiliate transaction processing. The transaction server according to the present invention processes the logic to achieve these ends. Although not ideal, the present system contemplates the requirement for ripping affiliate data when an API does not exist. This means that for authorized affiliates, the present system creates a process that browses affiliates' products and converts/passes them over to the server of the present invention.

The transaction server according to the present invention preferably effects direct transactions and certain transaction bypass means. For retail products connected through partner APIs, the mobile application 70 processes transactions in a manner that is typical for the purchase of goods on mobile communications devices 10. For scraped retail information, a transaction bypass is created that allows the TRY IT ON—ONLINE™ mobile application to process a transaction from the consumer application 70 that would otherwise require a direct transaction on the products retail website. To put this simply, the mobile application according to the present invention handles transaction(s) on the front end, but the application backend will place the order on behalf of the user with the TRY IT ON—ONLINE™ account, thereby creating a seamless transaction experience.

While the foregoing specifications set forth much specificity, the same should not be construed as setting forth limits to the invention but rather as setting forth certain preferred embodiments and features. For example, as prefaced hereinabove, it is contemplated that the present invention essentially provides a computer-implemented mobile application system for enabling a user to view the appearance of clothing as virtually worn by the user upon a mobile communications device as at 10.

The computer-implemented mobile application system according to the present invention preferably comprises in combination: a mobile communications device as at 10 and mobile application software as at 70. The mobile communications device 10 preferably comprises certain software implementation means and a visual display as at 11. The mobile application software 70 is implementable via the software implementation means of the mobile communications device 10 and preferably comprises certain software driven features or means for achieving various ends as discussed briefly hereinafter.

The mobile application software 70 preferably comprises certain image retrieval means for retrieving a first image or clothing image as at 26 (e.g. from a website as at 12) and a second image or facial image as at 39 from photographic data made available to the mobile application 70.

The mobile application software 70 further preferably comprises certain image-manipulation means for (1) manipulating a retrieved clothing image 26 (e.g. removing a model's head 29 from a graphic image as at 26 and/or resizing a dress or article of clothing 27) for producing a manipulated clothing image as at 30) and (2) manipulating a retrieved facial image 39 (e.g. a built-in graphic tool that automatically crops out the background 21, inclusive of the person's non-facial bodily features 23 and any unwanted ornamentation such as earrings 24, resizes the facial image 39, corrects skin color, skin tone and/or sharpens the facial features from the retrieved image 39) so as to produce a corrected image as at 25.

The mobile application software 70 further preferably comprises certain image overlay means for overlaying a manipulated facial image as at 25 with a manipulated clothing image as at 30 as generally depicted in FIG. 7. Further, the mobile application software 70 preferably comprises certain visual display means for visually displaying overlayed facial image 25 and clothing image 30 upon the visual display 11 of the mobile communications device 10 as generally depicted in FIG. 8.

The computer-implemented mobile application system according to the present invention thus enables the user to preview the appearance of clothing as virtually worn by the user upon the mobile communications device 10. The system, however, may further comprise certain complexion data input means (i.e. the mobile application 70 prompts the user to input skin color and/or skin tone information as selected from a compilation 22 of skin colors and skin tones) and the image-manipulation means comprises certain complexion correction means (i.e. made part of the built-in graphic tool that automatically corrects skin color and/or skin tone based on data input by the user). The complexion correction means basically function to manipulate the retrieved facial image 39 to correct skin color and/or skin tone according to a user's complexion data input via the complexion data input means.

The mobile application system according to the present invention may further preferably comprise certain body data input means (i.e. the mobile application 70 prompts the user to input body shape and or body size information or attributes), certain clothing dimension data retrieval means (as retrieved from website data or areas as at 28 associated with image 26), and certain data comparison means for (1) comparing a user's body data input via the body data input means versus clothing dimension data cooperably associated with the retrieved clothing image and (2) indicating clothing suitability (i.e. via either no warnings 32 or warnings 32 upon the visual display 11) based on the user's body data input.

The body data input may preferably comprise body shape information and body size information. The body shape information is preferably selected from a body shape group, the body shape group consisting of triangular (as at 14), inverted triangular (as at 15), rectangular (as at 16), hourglass (as at 17), diamond (as at 18), and round (as at 19) body shapes as generally depicted in FIG. 1. The body size information may be preferably selected from the following exemplary attributes: bust size, cup size, hip size, height, weight, and inseam.

The mobile application system according to the present invention may further preferably comprise certain body type-to-clothing matching means for simultaneously presenting multiple overlayed facial and clothing images as at 80 and 81 for simultaneous side-by-side comparison upon the visual display 11. Preferably, the body type-to-clothing matching means are launched by logo-branded (as at 73) one-click means located upon the visual display screen 11 or at the website 12.

The mobile application system according to the present invention may further preferably comprise certain mapping means for presenting the user with a visual map as at 54 upon the visual display screen 11, which map 54 pinpoints retailer outlets 55 having clothing inventory matching body shape and body size data input by the user. The mobile application system according to the present invention may further preferably comprise alternate transaction processing means, which alternate transacting processing means are preferably selected from the group consisting of direct transaction processing and transaction bypass processing as described hereinabove.

In addition to the various structural or systemic aspects of the invention, it is believed that the foregoing specifications further support certain methodological advancements or certain methods for enabling a user to view the appearance of clothing as virtually worn by the user upon a mobile communications device 10. The computer-implementable method may be said to preferably comprise the initial step of providing certain mobile application software, the mobile application software being implementable via software implementation means cooperably associated with a mobile communications device 10.

A first image or clothing image and a second image or facial image may then be retrieved via certain image retrieval means of the mobile application software. The retrieved clothing image and a retrieved facial image may then be manipulated via certain image-manipulation means of the mobile application software, and a manipulated facial image may be overlayed with a manipulated clothing image via image overlay means of the mobile application software for visually displaying the overlayed facial and clothing images upon a visual display cooperably associated with the mobile communications device.

Accordingly, although the present invention has been described by reference to certain preferred arrangements and certain methodologies, it is not intended that the novel arrangements and methods be limited thereby, but that modifications thereof are intended to be included as falling within the broad scope and spirit of the foregoing disclosures, the following claims, and the appended drawings.

I claim:

1. A computer-implemented mobile application system for enabling a user to view the appearance of clothing as virtually worn by the user upon a mobile communications device, the computer-implemented mobile application system, comprising, in combination:
a mobile communications device, the mobile communications device comprising software implementation means and a visual display;
mobile application software, the mobile application software being implementable via the software implementation means, the mobile application software comprising:
image-retrieval means, the image-retrieval means for retrieving a clothing image and a facial image of the user;
image-modification means, the image-modification means for modifying a retrieved clothing image and a retrieved facial image;
image-overlay means, the image-overlay means for overlaying a modified clothing image and a modified facial image; and
visual display means, the visual display means for visually displaying overlayed modified clothing and facial images upon the visual display;
the computer-implemented mobile application system thus enabling the user to preview the appearance of clothing as virtually worn by the user upon said mobile communications device.

2. The mobile application system of claim 1 comprising complexion data input means, the image-modification means comprising complexion-correction means, the complexion-correction means for modifying the retrieved facial image to correct skin color and/or skin tone according to a user's complexion data input via the complexion data input means.

3. The mobile application system of claim 2 comprising body data input means, clothing dimension data retrieval means, and data comparison means, the data comparison means for (1) comparing a user's body data input via the body data input means versus clothing dimension data cooperably associated with the retrieved clothing image and (2) indicating clothing suitability upon the visual display based on the user's body data input.

4. The mobile application system of claim 3 wherein the body data input comprises body shape and body size information.

5. The mobile application system of claim 4 wherein the body shape information is selected from a body shape grouping, the body shape grouping consisting of triangular, inverted triangular, rectangular, hourglass, diamond, and round body shapes.

6. The mobile application system of claim 5 comprising body type-to-clothing matching means, the body type-to-clothing matching means for simultaneously presenting multiple overlayed clothing and facial images for simultaneous side-by-side comparison.

7. The mobile application system of claim 6 wherein the body type-to-clothing matching means are launched by logo-branded, one-click means located upon the visual display.

8. The mobile application system of claim 6 comprising mapping means, the mapping means for presenting the user with a visual map upon the visual display of retailers having inventory matching data input by the user.

9. The mobile application system of claim 1 comprising alternate transaction processing means, the alternate transacting processing means being selected from the group consisting of direct transaction processing and transaction bypass processing.

10. The mobile application system of claim 1 comprising data-editing means, the data-editing means for enabling the user to selectively edit data input by the user.

11. A computer-implementable mobile application for enabling a user to view the appearance of clothing as virtually worn by a target subject upon a mobile communications device, the computer-implementable mobile application comprising:
mobile application software, the mobile application software being implementable via software implementation means cooperably associated with a mobile communications device, the mobile application software comprising:
image-retrieval means, the image-retrieval means for retrieving a clothing image and a facial image of the target subject;
image-modification means, the image-modification means for modifying a retrieved clothing image and a retrieved facial image;
image-overlay means, the image-overlay means for overlaying a modified clothing image and a modified facial image; and
visual display means, the visual display means for visually displaying overlayed modified clothing and facial images upon a visual display cooperably associated with the mobile communications device;
the mobile application thus for enabling the user to preview the appearance of clothing as virtually worn by the target subject upon said mobile communications device.

12. The mobile application of claim 11 comprising complexion data input means and the image-modification means comprises complexion correction means, the complexion correction means for modifying the retrieved facial image to correct skin color and/or skin tone according to complexion data input via the complexion data input means.

13. The mobile application of claim 11 comprising body data input means, clothing dimension data retrieval means, and data comparison means, the data comparison means for (1) comparing body data input via the body data input means versus clothing dimension data cooperably associated with the retrieved clothing image and (2) indicating clothing suitability upon the visual display based on the body data input.

14. The mobile application of claim 13 wherein the body data input comprises body shape and body size information.

15. The mobile application of claim 14 wherein the body shape information is selected from a body shape grouping, the body shape grouping consisting of triangular, inverted triangular, rectangular, hourglass, diamond, and round body shapes.

16. The mobile application of claim 13 comprising body type-to-clothing matching means, the body type-to-clothing matching means for simultaneously presenting multiple overlayed clothing and facial images for simultaneous side-by-side comparison.

17. The mobile application of claim 16 wherein the body type-to-clothing matching means are launched by logo-branded, one-click means located upon the visual display.

18. The mobile application of claim 13 comprising mapping means, the mapping means for presenting the user with a visual map of retailers having inventory matching data input by the user.

19. The mobile application of claim 11 comprising alternate transaction processing means, the alternate transacting processing means being selected from the group consisting of direct transaction processing and transaction bypass processing.

20. A computer-implementable method for enabling a user to view the appearance of clothing as virtually worn by a target subject upon a mobile communications device, the computer-implementable method comprising the steps of:
providing mobile application software, the mobile application software being implementable via software implementation means cooperably associated with a mobile communications device;
retrieving a clothing image and a facial image of the target subject via image-retrieval means of the mobile application software;
modifying a retrieved clothing image and a retrieved facial image via image-modification means of the mobile application software;
overlaying a modified clothing image with a modified facial image via image overlay means of the mobile application software; and
visually displaying overlayed modified clothing and facial images upon a visual display cooperably associated with the mobile communications device.
